(19) United States
(12) Patent Application Publication
(10) Pub. No.: US 2020/0085114 A1
(43) Pub. Date: Mar. 19, 2020

(54) GARMENT, IN PARTICULAR FOR THE TORSO

(71) Applicant: CALCEVIVA S.N.C. DI SIMEONE BRUNO, Martina Franca (TA) (IT)

(72) Inventors: Daniele Antonio DEL GENIO, Martina Franca (TA) (IT); Bruno SIMEONE, Martina Franca (TA) (IT); Luca Carlo Maria RIZZI, Martina Franca (TA) (IT); Sarah DE CRISTOFARO, Martina Franca (TA) (IT)

(73) Assignee: CALCEVIVA S.N.C. DI SIMEONE BRUNO, Martina Franca (TA) (IT)

(21) Appl. No.: 16/472,906

(22) PCT Filed: Dec. 20, 2017
(86) PCT No.: PCT/IB2017/058208

§ 371 Date: Jun. 24, 2019

(30) Foreign Application Priority Data
Dec. 23, 2016 (IT) 102016000130809

(51) Int. Cl. A41D 1/00; A41D 1/02; A62B 7/10; A62B 18/08; F03G 5/06

(52) U.S. Cl. CPC A41D 1/002; A41D 1/02; F03G 5/06; A62B 18/084; A62B 7/10

(57) ABSTRACT

A garment having a portion opened frontally, with a pair of flaps configured to be connected to respective edges of a central band extending from the lower edge to the collar of the garment. A connector is provided between the flaps and the edges and is capable of insulating the services accessible with the garment as an interchangeable element, further subjected to less stresses than other portions of the garment and easily detachable therefrom. The central band includes one or more watertight insulated and protected volumes, having therein electric and/or electronic service devices, filters, or other articles to be protected, and a system to assist breathing.

The present invention relates to a garment apt to be worn on the torso, like a jacket, a gilet, a technical heavy jacket, a dust coat, a raincoat, a coat, an overcoat, a down jacket, or the upper portion of a tracksuit or a cardigan.

Such garment then comprises a waistcoat, apt to wrap the user torso, which is frontally opened, with a pair of flaps intended to be connected to the respective edges of a central band extending from the lower edge to the collar of the garment, means for quick connection being provided between said flaps and said edges, as described for example in European patent application N. 2,898,786 A2.

Garments such as tracksuits and heavy jackets are known which have performances of technical type and can provide the user a series of services ranging from depuration of air to be breathed to the presence of sensors of various type and of so-called wearable electronic devices, as well elements for the passive or active lighting, or systems for the energy production and/or accumulation.

However, this type of clothing is considered of technical type and, although it is useful under specific circumstances in which it is worn, it is not considered a more permanent use garment, as the services provided thereby are requested only occasionally.

Moreover, these garments of technical type are intended for a specific use, and they cannot offer a range of interchangeable services concentrated in one single garment, and this contributes to limit the use field to specialized operators, for example sportsmen, firemen, health workers and so on, who consider this type of clothing as working garment, only suitable to that aim.

The technical problem underlying the present invention is to provide a garment for the torso allowing to obviate the drawback mentioned with reference to the known art.

Such problem is solved by a garment as above specified, characterizes in that the central band comprises one or more waterproof insulated and protected volumes, having inside thereof service devices and a system helping in breathing as specified in appended claim 1.

The main advantage of the garment according to the present invention lies in the capability of insulating the services accessible with the garment in an interchangeable element thereof, further subject to less stresses than other portions of the garment and easily detachable therefrom.

The present invention will be described hereinafter according to some embodiment examples and related variants, provided by way of example and not with limitative purposes with reference to the enclosed drawings wherein:

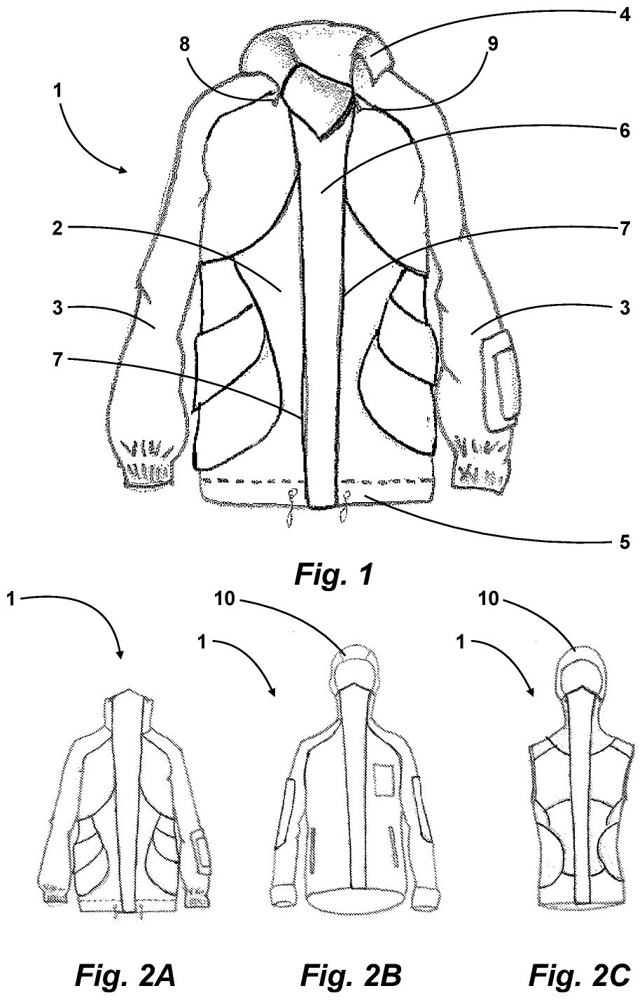

FIG. 1 shows a front view of a garment, in particular a heavy jacket, according to the present invention;

FIG. 2A shows a front view of the heavy jacket of FIG. 1 in closed configuration;

FIG. 2B shows a front view of a heavy jacket according to the present invention provided with a hood;

FIG. 2C shows a front view di un gilet according to the present invention, provided with a hood;

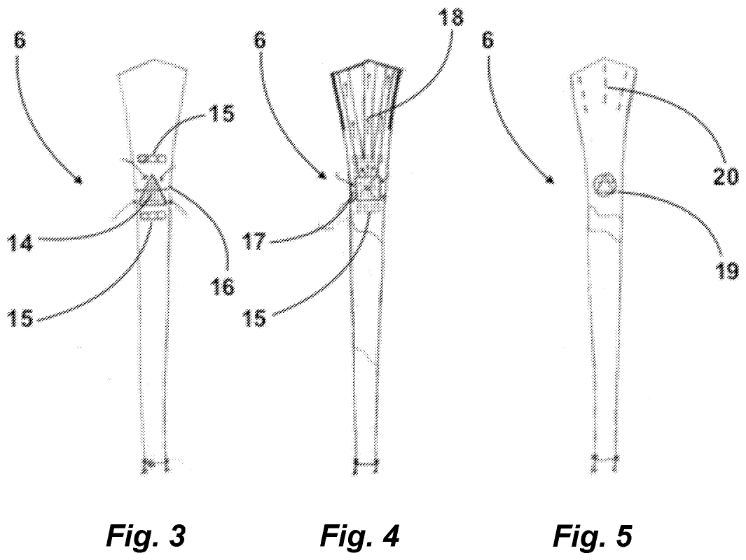

FIG. 3 shows a front view of a central band which is used in a garment according to the present invention;

FIG. 4 shows a section view of the central band of FIG. 3;

FIG. 5 shows a rear view of the central band of FIG. 4B;

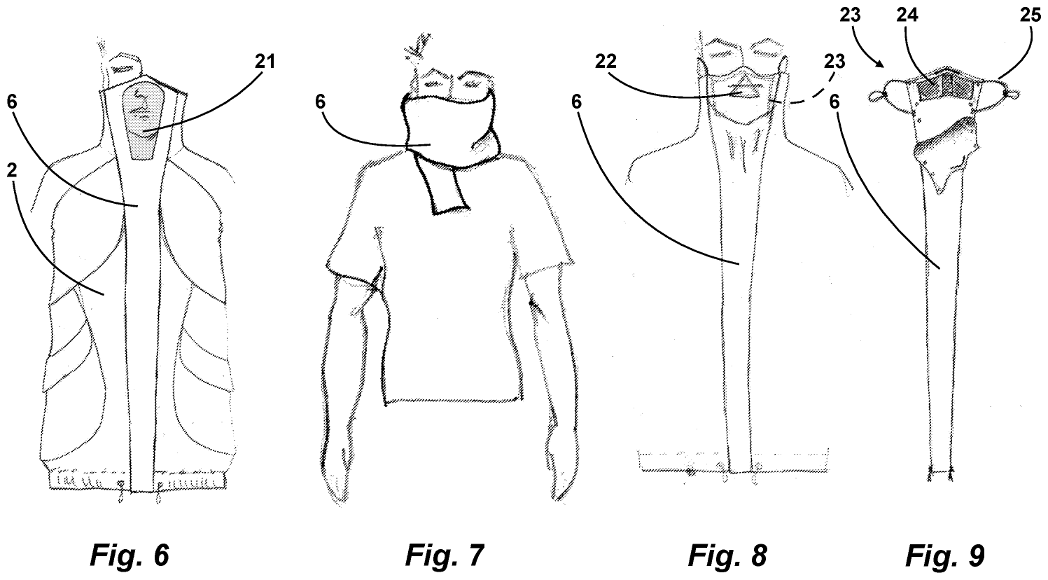

FIG. 6 shows a partial front view of a garment according to the invention with a central band according to a first variant;

FIG. 7 illustrates, with a front view of a user, an alternating use of a central band of one of the preceding figures;

FIG. 8 shows a partial front view of a garment according to the invention with a central band according to a second variant; and

FIG. 9 shows a front view in partial section of the central band of FIG. 8.

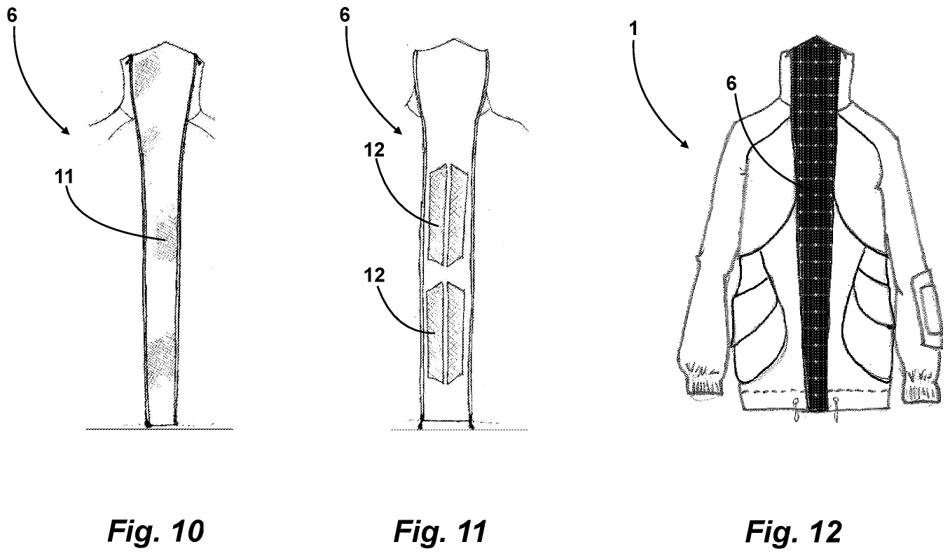

FIG. 10 shows a front view of a central band according to a third variant of the present invention, for illustrating additional accessories;

FIG. 11 shows a front view of a central band according to a fourth variant of the invention, for illustrating additional accessories; and

FIG. 12 shows a front view of a heavy jacket according to the invention with a central band according to a fifth variant, for illustrating additional accessories.

By referring to figures, a garment 1 for the torso or, by referring to FIG. 1, a jacket is described, comprising a waistcoat 2, sleeves 3, a collar 4 for example of the lapel-like type, and a lower waist edge 5, in case adjustable in extension thanks to an inner lace.

The waistcoat 2 is of the frontally opened type, and it then provides a pair of flaps 7 intended to be joined therebetween to close the jacket 1.

On this regard, the garment 1 comprises a central band 6, extending vertically and which has side edges thereto respective flaps 7 are coupled for closing frontally the garment 1; each flap is joined to the respective edge of the band 6 by means of a first zipper 8 and a second zipper 9, extending from the neck to the waist.

Therefore, it is to be meant that the garment 1 can be opened or half-opened by acting on only one of the two zippers 8, 9, or by acting on both of them and by removing the band 6.

The two zippers constitute means for quick connection of the central band 6 to the flaps 7 of the garment 1.

The previously described garment 1 can implement a unisex garment for the upper portion of the body, such as for example a jacket, a gilet, a coat, a raincoat, an overcoat, a windproof or rainproof jacket/gilet and/or, a dust coat, a down jacket or a cardigan to be used to protect one's own health from the effects of the pollutants existing in the air without renouncing to the taste in the way of dressing and to comfort.

The garment 1 can provide the removal of the sleeves and the presence of a hood 10, which can be removed and/or closed in the collar 4.

It is to be noted that the central band 6 not only is wholly removable but it is can even be replaced and it allows to open the jacket easily both with the right hand and the left hand. Therefore, the garment 1 can provide not one single band 6 but a kit of bands with different colour, material and use functionality, as it will appear hereinafter in greater detail.

The central band 6 develops for the whole length of the garment from the base to the collar, as far as covering suitably the respiratory tracts. The zippers 8, 9 mentioned previously can be replaced by other closing systems, for example strips made of Velcro®, magnetic strips or buttons, as alternative form of the above-mentioned means for quick connection.

The garment 1, the central band 6 and the hood 10 can be made of materials, not necessarily equal therebetween, having an adequate tear resistance, a breathability, water-tightness, heat and/or thermal insulation suitable to the use case and, generally, to the use in outer environments. Materials implemented through layers of functionalized membranes are preferred, since they are capable of providing at the same time lightness and good wearability to the whole garment, such as GORETEX®, SIMPATEX®, DEFENDER®, POLARTEC® and the like. Should the garment 1 be devised to be used at low temperatures, the garment, the central band 6 and the hood 10 can be made of a breathable, watertight and insulating material, and they can be padded inside with material capable of keeping heat effectively, such as goose feathers, synthetic padding, POLARTEC® Alpha, THERMOLITE®, and so on.

The central band 6 can be even made of double face fabric, so as to be able to create a series of different combinations with the garment 1 on which is it connected. Even the garment itself in turn can be made of double face fabric. In each type of garment, by combining the colours and the finishing of the garment 1 and of the central band 6 it is possible to obtain four different couplings of colours and materials. An additional customization of the garment can be provided by the presence of the hood 10 and/or by the removal of the sleeves 3.

The central band 6 can be worn by wholly connecting its edges to the flaps 7 of the garment 1, thus covering suitably the respiratory tracts. On this regard, the band 6 comprises a system for helping breathing which will be described hereinafter.

In particular, the central band 6 which is used in the previously described jacket is provided with complex active filtration systems, integrated inside thereof, based upon:
the recovery of air, from the surrounding environment, by means of a sucking system (for example valves at the solid state, axial mini-valves and/or centrifuges and the like);
the purification of the air sucked through specific filters (HEPA filters and the like) with sizes and geometry adequate to maximize the filtration area and the filter life;
the channelling of clean air through a valve, through a system of small tubes or a single tube with circular, and not, section, made of material adequate not to disperse air and suitably hidden inside the central band 6;
the supply of purified air near the user respiratory tracts.

By referring to this solution and to FIGS. 3 to 5, the band 6 frontally has a suction nozzle 14, near thereof sensors 15 are arranged which verify the air quality.

Below the nozzle 14 filters 16 are positioned therebelow a valve 17 is provided arranged inside a sealed casing, accessible through a cover 19 arranged on the back of the band 6.

The valve 17 conveys the air sucked and filtered by the filters 16, through ducts 18 obtained inside the band 6, in the thickness thereof. The ducts 18 end at openings 20 arranged on the inner face of the band 6, at the upper end thereof which overlaps to the user respiratory tracts.

The upper area of the central band 6 and the collar 4 of the garment create an area sheltered from air currents and thus implement a preferential volume for supplying purified air near the respiratory tracts.

The supplied air can be further purified by an active/passive filtration system, near the collar 4; then it will have the guarantee to remain more near the user by obviating the problems and the troubles typical of a mask rested upon the face.

In this configuration, the central band 6 is implemented by three layers: outer, intermediate and inner. The outer layer provides an extended area or some smaller and distributed areas, connected to the sucking system through a channelling system suitable to avoid possible throttling when the garment is worn, by allowing to take air from the surrounding environment. The sucking areas are suitably provided with specific filters assembled on frames made of half-rigid/flexible material, which allow, thanks to the presence of hooking/quick-releasing systems existing on the outer layer of the band, an easy replacement of the filter itself for maintenance or presence of different pollutants. A layer of breathable fabric covers the filters, by making the central band 6 aesthetically pleasant.

Tue sucking, channelling and supplying system is hidden inside the central band 6, framed or sewn on the intermediate layer.

The channelling system for supplying clean air can be implemented by using small tubes made of plastic material constrained outside the intermediate layer of the band or inserted in fairlead tubular slots/pockets made of fabric on the intermediate layer or made directly of fabric suitable to guarantee the air passage with low losses.

The inner layer of the central band 6, at the respiratory tracts, has a series of holes or slots 20 allowing to supply the purified air in the volume of interest and of an access point for the maintenance of the electronic components constrained on the intermediate layer.

In a possible configuration thereof (FIG. 7) the central band 6 can be used alone and worn in collar or scarf mode. The functions and equipment of the band, however, could act even in this configuration and in particular the air filtration functions will be guaranteed when the user keeps near his/her face the same areas of the band kept near the face when the band is fastened on the garment.

The portion of central band 6 at the face can further provide the application of a window 21 made of transparent material, for example PVC, capable of facilitating the expressive communication of the user by making the motions of his/her mouth visible to outer people (FIG. 6). In this configuration, the channelling system for supplying the purified air will be conveyed in the peripheral areas of the above-mentioned transparent window 21 of the band 6.

The central band 6, in an additional configuration (FIGS. 8 and 9), can be provided with one or more passive filtration systems 24 contemporarily, for example filters for PM10, filters for PM2.5, activated charcoal filters and so on, previously assembled on a frame 23 made of half-rigid material or subsequently assembled on a half-rigid/flexible material sewn on the inner fabric of the band itself. In case of frame made of half-rigid or flexible material, the inner surface of the central band 6 will be provided with dedicated hooking and quick releasing systems, such as clip, Velcro®, magnetic bands and the like, which make the filter replacement quick and easy. A layer of breathable fabric covers the filtration system, by making the central band 6 aesthetically pleasant, with a suction hole 22 arranged at the respiratory tracts.

Moreover, the fact of covering these elements from wear, exposure to air, rain or sun light allows to increase the useful life of the above-mentioned elements.

The system of filters is housed in the upper portion of the central band 6, with the purpose of guaranteeing the whole shielding of the user respiratory tracts when the band is connected to the garment and the garment correctly worn.

In order that the passive filtration system is comfortable and effective, the insulation of the user respiratory tracts from the outer environment and a good wearability have to be guaranteed.

To this purpose the central band 6 can integrate a frame element 23 made of mouldable material, positioned along the upper circumference of the central band 6 and integrated therein, which allows the user to adapt manually or mechanically to one's face the area with passive filtration element. For the mechanical actuation of the mouldable element, inside of a stiff element placed on the band itself, elastic or spring pre-loaded mechanisms are implemented, which can be implemented by the user with one single hand for example by pressing a button or rotating a small crank.

Stiffening elements made of half-rigid or flexible material are further provided, placed at the respiratory tracts, so that the passive filtration area, once positioned on the user face, leaves sufficient space between the mouth and the fabric without resting on the lips and on the face portions not intended to breathe, by reducing a possible discomfort.

Moreover, one or more valves can be provided on a route for evacuating breath, functional even for controlling heat and humidity inside the mask and to improve the garment comfort and wearability. They are constrained to the central band, in the area wherein there is the passive filtration system, preferably in the stiffened area joining the collar and the central band.

At last, the frame 23 has available eyelet-like fastening laces 25, at the high side ends of the central band 6, to be worn on the ears to keep in correct position the passive filtration system and to favour the insulation from the outer environment.

In order to guarantee a comfortable use of the central band as filtering mask, the laces 25 could be adjusted by suitable adjusting system.

In a configuration, the eyelet-like laces of the band can be replaced by a double lace on the collar of the garment: the first one arranged along the most outer periphery of the collar, the second one arranged so as to join two points placed at the chin height and a point placed along the outer periphery of the collar, at the nape.

The double lace can be activated manually or by pressing a button or by revolving a crank which activates an integrated mini-mechanism, based upon an elastic system or pre-loaded springs. The manual, and not, actuation allows the portion of central band intended to passive filtration, being constrained to the collar of the garment, to adapt to the user face, by guaranteeing the insulation of the respiratory tracts from the outer environment.

The band 6 could then include a frame made of silicone material, applied by means of sewing on the inner fabric portion of the band, at the respiratory tracts and the passive filtration elements, shaped so that, when the eyelet-like laces are worn or the double lace is activated, the fact of keeping on the face portion in contact, chin included, and the insulation of the respiratory tracts from outside are guaranteed.

However, it is meant that the band 6 could be even left partially open at the right or left upper portion of the collar, thus leaving the respiratory tracts free and providing the possibility of lowering/folding the collar.

Moreover, the central band 6 can be implemented with different lengths so as to better adapt to the garment and to the padding worn below the garment depending upon the season, or the user size.

The central band 6 can be used as interchangeable element functional to customization of the garment 1. In particular, the central band 6 can be provided with one or more of the additional functions detailed hereinafter, thus allowing the maximum customization of the garment itself.

In case of a garment 1 devised for the hot season or which, based upon the intended use, does not request water-tightness, a portion or the whole surface constituting the central band 6 (FIG. 10) can be made of specific breathable fabric 11, such as netted fabric made of nylon, with the purpose of improving the inner ventilation of the garment itself.

These specific fabrics can be even used to implement inserts (FIG. 11) arranged along the band 6, in case to form a pattern thereon.

The central band 6, as it can be wholly detached from the remaining portion of the garment 1, is devised to be washed or treated in different manner from the remaining garment. In particular, the use of water-tight materials and seams allows the central band to include insulated and water-tight and/or protected volumes, which allow to insert inside the band 6, even components which otherwise would make the whole clothes not washable, such as for example sensors, transmission means, electric and/or electronic portions, batteries; it is meant that such list is not exhaustive and it is only exemplifying.

These insulated volumes in particular allow to concentrate, at the central band 6, filters, sensors o electric and/or electronic service devices, without making the garment 1 heavier.

A jacket-like garment then could have a kit of central bands, one or more thereof without service devices and other ones capable of providing the user different services, as many as the bands of the kit arranged to this purpose.

The above-mentioned insulated volumes could be closed and not accessible but they could be in communication with other elements or devices, inside or outside the band, by means of cables, tubes, tie rods and the like. On the contrary, such volumes could be constituted by pockets which can be closed again and accessed in order to put devices to be protected, such as a smartphone, a watch, money, documents, credit cards, position transmitters, for example RFID, localizers, for example GPS or Wi-Fi®, acoustic alarms, timer, or any delicate object sensitive to bad weather or humidity.

The above-mentioned volumes in case could be coated with anti-impact material.

The central band 6 can be provided with luminescent elements, which could be fixed and/or removable, with function of passive lighting, which make more visible the user, or with function of active lighting, in case useful to the user to illuminate the front space. They can be implemented by means of LED, electroluminescent sheets or the like. In both cases, the luminescent elements can be devised to be applied directly on the fabric thereof the central band 6 is made by means of seams, Velcro®, clip, and so on, or on the hooking/quick releasing systems, arranged along the larger sides of the band.

In case of active lighting elements, the central band 6 will be provided with a system for turning ON/OFF based upon a pressure mini-switch or on a luminosity sensor.

In the first case, the switch will be integrated in the inner or outer portion of the band, so as it can be easily activated by pressing the same light element or on a point recognizable through a texture/colour differentiated from the remaining portion of the garment.

In the second case, the sensor will be integrated inside a customized button/clip which, upon detecting a level of outer luminosity lower than that of the city lighting, sends an activation signal to the active lighting source. The detection of the light intensity is allowed by the presence of a hole on the button/clip, sized for the correct operation of the sensor and shielded with transparent material which allows to guarantee the water-tightness.

The central band 6 can be provided with additional sensors, suitably integrated inside the fabric to guarantee wearability, aesthetics and washability of the band itself. In particular, a series of sensors dedicated to the environmental monitoring (sensors PM2.5, PM10, CO₂, VOC and the like) and/or monitoring of the person (heart rate, respiratory frequency, temperature, accelerometers and so on) could be inserted.

In presence of sensors of any type, the central band 6 will be provided with systems for monitoring the functions of the band itself, such as the loading status of the battery for supplying the sensors, the evaluation of the filters' wear, as well as a system for communicating with the user based upon coded light feedback or an application on smartphone.

In the sustainability optics, the central band 6 can be provided with wearable systems for energy production, such as for example flexible photovoltaic panels, sewn directly on the band (FIG. 12), or piezoelectric systems capable of converting a vibration caused by the motion into energy, integrated in flexible or half-rigid elements. The accumulated energy can be then transferred to the remaining technological components integrated through dedicated connectors or conductive buttons, or by exploiting directly the two zippers which, since they are separate on their whole length, can become electrical conducting elements for the two required polarities.

To the above-described garment a person skilled in the art, with the purpose of satisfying additional and contingent needs, could introduce several modifications and variants, however all comprised within the protective scope of the present invention, as defined by the enclosed claims.

1. A garment (1) for a user's torso, comprising a frontally opened waistcoat (2), with a pair of flaps (7) configured to be connected to respective edges of a central band (6) extending from the lower edge (5) to a collar (4) of the garment (1), means for quick connection being provided between said flaps (7) and said edges, the central band (6) comprises at least one watertight insulated and protected volume comprising therein service devices, wherein said central band (6) comprises:
a suction nozzle (14), with sensors (15) arranged proximate thereto, which verify air quality;
a valve (17), accessible through a cover (19) arranged on a back portion of the central band (6), which receives air from said suction nozzle (14);
filters (16), for purifying air, positioned between the suction nozzle (14) and the valve (17); and
ducts (18) extending from said valve (17) within the central band (6) as far as an upper end thereof, said end comprising openings (20) arranged on an inner face of the band (6) proximate a user's respiratory tracts.

2. The garment (1) according to claim 1, wherein the central band (6) comprises a frame (23) whereon passive filtration systems (24) are positioned, with a suction hole (22) arranged proximate the user's respiratory tracts.

3. The garment (1) according to claim 2, wherein the frame (23) is made of moldable material, positioned along an upper circumference of the central band (6) and integrated therein, which allows the user to adapt, manually or mechanically, the area with the passive filtration system (24) to the user's face.

4. The garment (1) according to claim 2, wherein at least one valve for exhalation is provided in the central band (6).

5. The garment (1) according to claim 2, wherein the frame (23) comprises laces (25) for fastening to the user's ears or head.

6. The garment (1) according to claim 1, wherein said means for quick connection comprise zippers (8, 9).

7. The garment (1) according to claim 1, wherein the upper end of the central band (6), together with: the collar (4), a hood (10), or both the collar and a hood, form, at the user's respiratory tracts, a protected air volume.

8. The garment (1) according to claim 1, wherein the central band (6) comprises portions or inserts (12) made of breathable fabric (11).

9. The garment (1) according to claim 1, wherein said service devices comprise at least one of: an electric device, an electronic device, a sensor or a filter.

10. The garment (1) according to claim 1, wherein active or passive luminescent elements are arranged on the central band (6).

11. The garment (1) according to claim 1, wherein the central band (6) is provided with wearable systems for energy production.

12. The garment (1) according to claim 9, wherein said means for quick connection comprise two zippers and wherein said service devices can supply or receive energy by means of the two zippers acting as electrical conducting elements for required polarities.

13. The garment (1) according to claim 1, wherein a portion of central band (6) a user's face comprises a window (21) made of transparent material.
